(19) United States
(12) Patent Application Publication
(10) Pub. No.: US 2004/0078537 A1
(43) Pub. Date: Apr. 22, 2004

(54) De-fragmenting memory by re-booting based on usage

(76) Inventor: Patrick W. Fulghum, Boise, ID (US)

Correspondence Address: HEWLETT-PACKARD COMPANY, Intellectual Property Administration, P. O. Box 272400, Fort Collins, CO, 80527-2400, US

(21) Appl. No.: 10/273,832

(22) Filed: Oct. 18, 2002

(51) Int. Cl. G06F 12/00

(52) U.S. Cl. 711/165

(57) ABSTRACT

A de-fragmentation processor of a system determines whether to re-boot the system based on a time at which the system is expected to be idle. During the expected idle period, the de-fragmentation processor causes the system to re-boot.

### RELATED APPLICATION

This application is related to the following U.S. patent application, the disclosure of which is incorporated by reference herein:

application Ser. No. ______, bearing Attorney Docket No. 10018172-1, filed ______, entitled “De-Fragmenting Memory by Re-Booting Based on Time”, and naming Patrick W. Fulghum as inventor.

### TECHNICAL FIELD

This invention relates to methods and systems for de-fragmenting memory based on usage.

### BACKGROUND

Many electronic devices are implemented as embedded systems with limited, consumable memory resources. One example of such a device is a printer, which may be connected to one or more computers, either directly or via a network. The performance of embedded systems with limited memory resources is negatively impacted if the available memory becomes fragmented. Memory fragmentation commonly occurs, for example in a printer, when electronic documents of varying sizes are processed (i.e., printed) by the device.

Such devices typically have a system application that controls the functionality of the device. The system application is stored in memory, and therefore impacts the amount of memory available. For example, the smaller the amount of memory necessary to store the system application, the more memory will be available for supporting the device functionality.

Some system applications include complex de-fragmentation algorithms that can be executed to de-fragment memory, which increases the performance of the device. One problem with de-fragmentation algorithms implemented as part of a system application is that more memory is needed to store the system application (because of the complex de-fragmentation algorithm), and therefore less memory is available to support device functionality.

### SUMMARY

A method for de-fragmenting memory by automatically re-booting a system based on usage is described. The system is re-booted when it is determined that the system is not likely to be in use.

### BRIEF DESCRIPTION OF THE DRAWINGS

The same numbers are used throughout the drawings to reference like features and components.

FIG. 1 is a block diagram that illustrates various components of a network environment that includes an exemplary printing device.

FIG. 2 is a flow diagram that describes a method for de-fragmenting memory in an exemplary printing device.

### DETAILED DESCRIPTION

Introduction

The following describes de-fragmenting and reclaiming memory in an embedded system. The following method for de-fragmenting and reclaiming memory will be described with reference to a networked printer, but it is recognized that the described method may be implemented in any number of embedded systems with limited memory resources. Essentially all computer-based systems have limited memory that must be managed. Examples of other types of systems in which the described method may be implemented include telephone switching systems, personal computers, television set-top boxes, scanners, faxes, and other types of office equipment.

When a document is sent to a printer to be printed, the document, or some representation of the document, is typically stored in the printer's memory prior to printing. The document is typically deleted from the printer's memory after the document is successfully printed. Over time, as a printer receives, stores, prints, and deletes documents of various sizes, it is common for the printer's memory to become fragmented. Fragmented memory results in decreased printer performance.

When a printer is re-booted, the memory is wiped clean, and as a result, the printer's memory is no longer fragmented. However, it may take several minutes to re-boot a printer, and having the printer unavailable for several minutes may be unacceptable in an office environment in which the printer is heavily used. As such, it is important to determine an appropriate time to re-boot the printer that will result in de-fragmentation of the printer's memory and minimum usage impact.

Exemplary Memory De-Fragmentation Environment

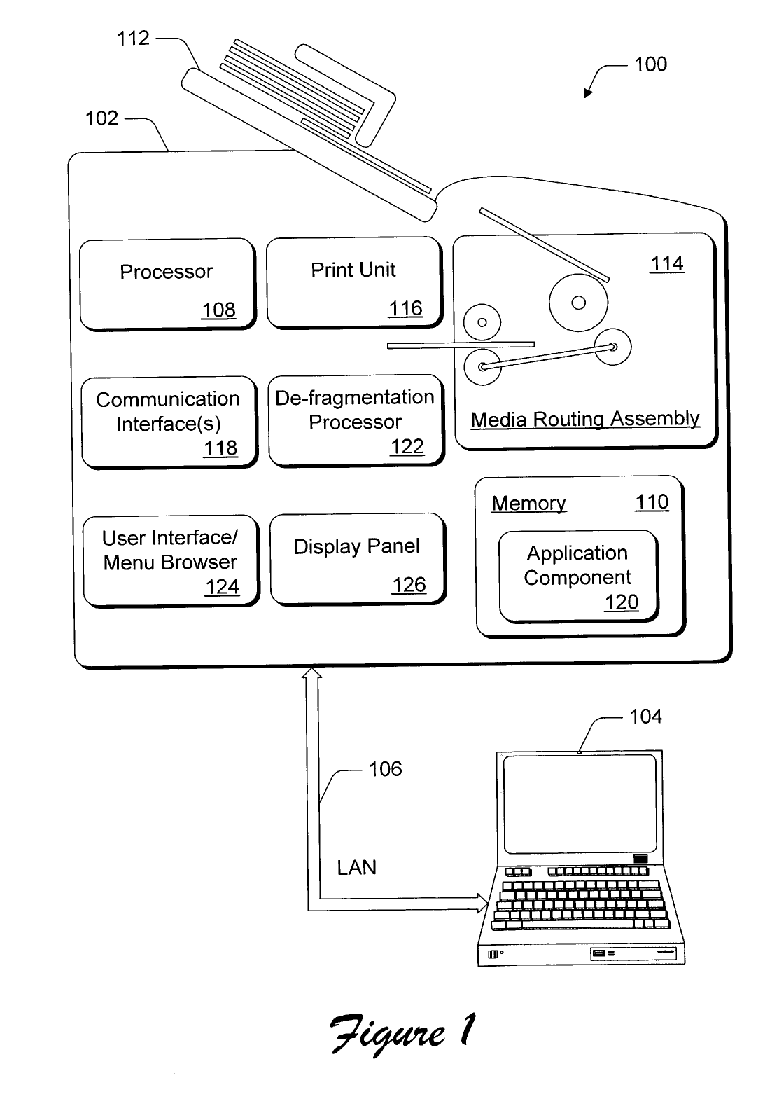

FIG. 1 illustrates components of a network environment 100 in which memory in a printing device 102 can be de-fragmented. Printing device 102 is connected with a computing system 104 via a data communication network 106.

Computing system 104 can be any type of computing system capable of communicating with printing device 102. The data communication network 106 can be any type of network, such as a local area network (LAN) or a wide area network (WAN), using any type of network topology and any network communication protocol. Although only a few devices are shown communicatively linked via network 106, a typical network can have any number of devices connected to it, either directly or indirectly via another network system. The Internet is an example of multiple connected network systems each having multiple devices. Printing device 102 and the computing system 104 can also have modems and/or network cards that facilitate network communication and data transfer via data communication network 106. Alternatively, printing device 102 and computing system 104 may be connected directly via a parallel, serial, USB, wireless, or other such connection.

Printing device 102 includes one or more processors 108, a memory component 110, a media tray 112, a media routing assembly 114, a print unit 116, and one or more communication interfaces 118. Additionally, although not shown, a system bus typically connects the various components within printing device 102.

Printing device 102 also includes an application component 120 that is implemented as a permanent memory module stored in memory component 110, or implemented with other components in printing device 102. For example, an application component can be implemented as a component of processor 108, or as a component of a printer controller. Application component 120 is programmed and tested like software, and is distributed with printing device 102. Application component 120 can be implemented to coordinate operations of the hardware within printing device 102 and contains programming constructs used to perform such operations.

Processor(s) 108 process various instructions to control the operation of printing device 102 and to communicate with other electronic and computing devices.

Memory component 110 stores various information and/or data such as configuration information, fonts, templates, print data, and menu structure information.

Media tray 112 holds physical print media, such as paper, plastic, fabric, Mylar, transparencies, and the like. The print media is fed from the media tray 112 to the media routing assembly 114, which sends the print media to the print unit 116 where an image is printed onto the print media.

Communication interface(s) 118 provide a connection between printing device 102 and one or more computing devices 104 or data communication networks 106. Communication interfaces 118 may include, for example, one or more of a parallel, serial, USB, wireless, or network interface. Implemented as a network interface, communication interface 118 allows devices coupled to a common data communication network to send print jobs, menu data, and other information to printing device 102 via the network 106. Similarly, implemented as a parallel, serial, or USB interface, communication interface 118 provides a data communication path directly between printing device 102 and another electronic or computing device.

Printing device 102 also includes a de-fragmentation processor 122, which may be implemented as part of application component 120, or as a separate component stored in memory, or implemented with other components in printing device 102. De-fragmentation processor 122 controls memory de-fragmentation by determining an appropriate time to re-boot the system, resulting in memory de-fragmentation.

Printing device 102 may also include a user interface and menu browser 124, and a display panel 126. The user interface and menu browser 124 allows a user of printing device 102 to navigate the device's menu structure. User interface 124 can include indicators and/or a series of buttons, switches, or other selectable controls that are manipulated by a user of the printing device. Display panel 126 is a graphical display that provides information regarding the status of printing device 102 and the current options available to a user through the menu structure.

Methods for De-fragmenting Memory by Re-Booting Based on Time

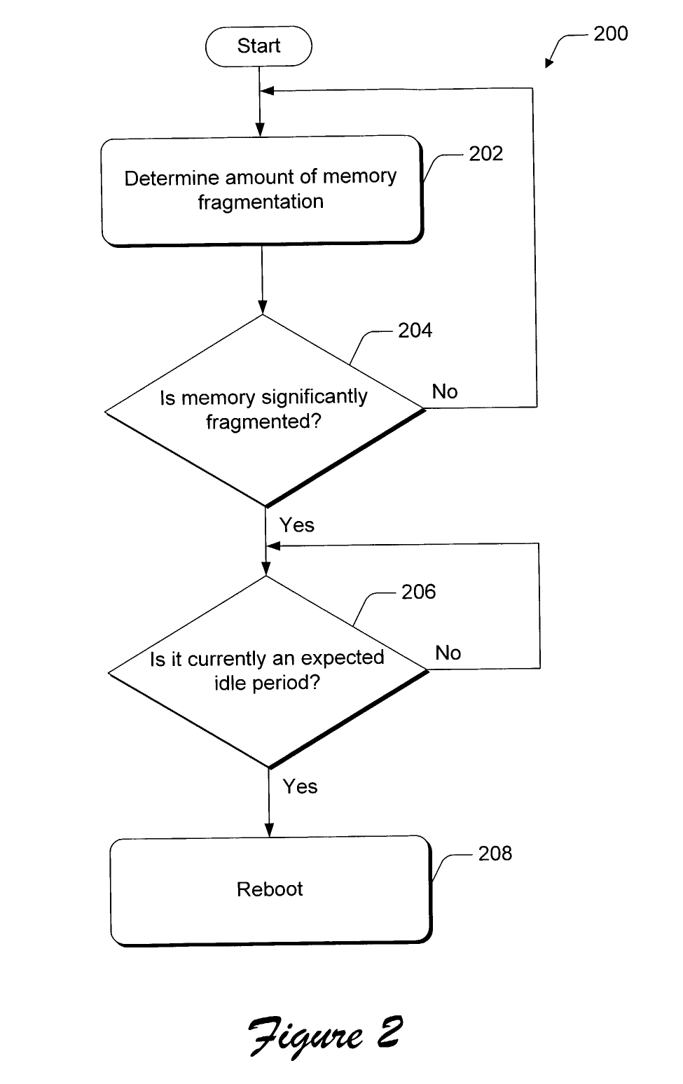

FIG. 2 illustrates a method 200 for de-fragmenting memory by rebooting a system. The order in which the method is described is not intended to be construed as a limitation. Furthermore, the method can be implemented in any suitable hardware, software, firmware, or combination thereof. In one embodiment, the method can be implemented by the system shown in FIG. 1.

At block 202, an application component determines the amount of memory fragmentation.

At block 204, the application component determines whether the memory is significantly fragmented. The degree of memory fragmentation that is considered significant may vary depending on the system. For example, in systems with small amounts of memory the system performance may decline when 25% of the memory is fragmented. Alternatively, performance of a system with a large amount of memory may not decline until the memory is 60% fragmented. In one implementation, the degree of memory fragmentation that is considered significant may be configurable by a user, for example, through a user interface associated with the system.

If the memory is not significantly fragmented (the “no” branch from block 204), then the method continues at block 202.

If it is determined that the memory is significantly fragmented (the “yes” branch from block 204), then at block 206, the application component determines whether the system is in an expected idle period. For example, the system maintains a five or seven day usage history. By examining the history, the application component is able to predict when the next idle period is expected to occur. For example, in an office environment, idle periods may be typical over a lunch hour and between the hours of 5:00 pm and 8:00 am.

At block 208, when it is determined that the current time is within an expected idle period, the application component causes the system to re-boot. After the re-boot, the memory is no longer fragmented and the system is in a ready state.

In an alternate implementation, the system may not examine the memory to determine the degree to which it is fragmented, but may just initiate a system re-boot based on the determination that the system is in an expected idle period.

Conclusion

Re-booting a system (e.g., a printer) during an expected idle period facilitates de-fragmentation of the system memory without negatively impacting the system users.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A method for de-fragmenting system memory of a system, comprising:
determining a time period during which the system is expected to be idle; and
during the determined time period, de-fragmenting the system memory by re-booting the system.

2. The method as recited in claim 1, wherein the determining comprises determining that the system is in a power save mode.

3. The method as recited in claim 1, wherein the time period is at least as long as an amount of time required to re-boot the system.

4. The method as recited in claim 1, wherein the determining comprises:
maintaining a record of idle time periods associated with the system; and
comparing a current time with the record to determine an expected idle time period.

5. The method as recited in claim 4, wherein the record comprises a listing of idle time periods occurring over a period of five days.

6. The method as recited in claim 1, wherein the determining and de-fragmenting are performed by a printer.

7. The method as recited in claim 1, further comprising:
prior to rebooting the system, determining whether the system memory is fragmented; and
de-fragmenting the system memory in response to determining that the system memory is fragmented.

8. A method comprising:
ascertaining when a printer is expected to be idle; and
automatically rebooting the printer when the printer is expected to be idle to de-fragment printer memory.

9. The method as recited in claim 8, wherein the ascertaining comprises determining whether the printer is expected to be in a power save state.

10. The method as recited in claim 8, wherein the ascertaining comprises identifying an expected idle time period that is at least as long as an amount of time required to re-boot the printer.

11. The method as recited in claim 8, wherein the ascertaining comprises:
maintaining a record of idle time periods associated with the printer; and
comparing a current time with the record to determine an expected idle time period.

12. The method as recited in claim 8, further comprising:
prior to rebooting the printer, determining whether printer memory is fragmented; and
automatically rebooting the printer in an event that the printer memory is fragmented.

13. A method comprising:
determining a degree to which printer memory is fragmented;
in an event that the degree to which the printer memory is fragmented is greater than a fragmentation threshold, determining a time period during which the printer is expected to be idle; and
during the determined time period, causing the printer to re-boot to de-fragment the printer memory.

14. The method as recited in claim 13, wherein the fragmentation threshold is at least 60%.

15. The method as recited in claim 13, wherein the fragmentation threshold is configurable.

16. A system comprising:
memory; and
a de-fragmentation processor configured to reboot the system when the system is expected to be idle.

17. A system as recited in claim 16, further comprising:
an idle time tracker configured to record periods of time during which the system is idle and determine expected idle time periods.

18. A system as recited in claim 16, implemented as a printer.

19. A system as recited in claim 16, implemented as a networked printer.

20. A system comprising:
memory;
an idle time tracker configured to record periods of time during which the system is idle and determine expected idle time periods; and
a de-fragmentation processor configured to reboot the system during an expected idle time period to de-fragment the memory.

21. A system as recited in claim 20, implemented as a printer.

22. A system as recited in claim 20, implemented as a networked printer.

23. One or more computer-readable media comprising computer executable instructions that, when executed, direct a computing system to:
determine a time period during which the system is expected to be idle; and
during the time period that is determined, de-fragment system memory by rebooting the system.

24. The one or more computer-readable media as recited in claim 23 further comprising computer executable instructions that, when executed, direct the computing system to:
maintain a record of idle time periods associated with the system.

25. The one or more computer-readable media as recited in claim 23 further comprising computer executable instructions that, when executed, direct the computing system to:
determine whether the system memory is fragmented.

26. One or more computer-readable media comprising computer executable instructions that, when executed, direct a printer to:
maintain a record of time periods during which the printer is idle;
determine a time period during which the printer is expected to be idle; and
during the time period that is determined, cause the printer to re-boot to de-fragment memory associated with the printer.

27. The one or more computer-readable media as recited in claim 26 further comprising computer executable instructions that, when executed, direct the printer to:
determine that printer memory is fragmented.

28. One or more computer-readable media comprising computer executable instructions that, when executed, direct a printer to:
determine a degree to which printer memory is fragmented;
compare the degree to a fragmentation threshold;
in an event that the degree is greater than the fragmentation threshold, determine a time period during which the printer is expected to be idle; and
during the time period that is determined, cause the printer to re-boot.

29. A printer comprising:
means for identifying an expected idle time period associated with the printer; and
means for rebooting the printer during the expected idle time period to de-fragment system memory.

30. A system comprising:
means for generating a record of system idle time;
means for determining an expected system idle time based on the record; and
means for rebooting the system during the expected system idle time.

31. A system as recited in claim 30, further comprising:
means for determining whether memory associated with the system is fragmented; and wherein the means for rebooting reboots the system in an event that the memory is fragmented.

32. A system as recited in claim 30, further comprising:
means for determining a degree to which memory associated with the system is fragmented; and wherein the means for rebooting reboots the system in an event that the degree is above a threshold.
